(19) United States
(12) Patent Application Publication
(10) Pub. No.: US 2008/0122631 A1
(43) Pub. Date: May 29, 2008

(54) MULTIPLE BAND / WIDE BAND RADIO FREQUENCY IDENTIFICATION (RFID) TAG, SUCH AS FOR USE AS A METAL MOUNT TAG

(75) Inventors: Venkata S. Kodukula, Bothell, WA (US); For Sander Lam, Bothell, WA (US); Pavel Nikitin, Seattle, WA (US); Richard A. Phillips, Lynnwood, WA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: INTERMEC IP CORP., Everett, WA (US)

(21) Appl. No.: 11/564,691

(22) Filed: Nov. 29, 2006

(51) Int. Cl. G08B 13/14

(52) U.S. Cl. 340/572.8

(57) ABSTRACT

A radio frequency identification (RFID) tag is adapted to operate with a wideband or multiple band of frequencies, such as 860-960 MHz. The RFID tag includes a flexible antenna inlay structure that can be integrated into a rigid structure to form a rigid RFID tag. The antenna inlay structure can be folded to provide a compact rigid RFID tag. The antenna inlay structure may also be used in a smart label. The antenna inlay structure can work with RFID chips operating under Gen 2, ISO, or other protocol. The RFID tag can be provided with a metallized label that operates to shield the antenna inlay structure against electromagnetic effects of an object (such as a metallic object) having the RFID tag affixed thereon.

### TECHNICAL FIELD

This disclosure generally relates to the field of automatic data collection (ADC), for example, data acquisition via radio frequency identification (RFID) tags. More particularly but not exclusively, the present disclosure relates to a structural configuration of an RFID tag.

### BACKGROUND INFORMATION

The ADC field includes a variety of different types of ADC data carriers and ADC readers operable to read data encoded in such data carriers. For example, data may be encoded in machine-readable symbols, such as barcode symbols, area or matrix code symbols, and/or stack code symbols. Machine-readable symbols readers may employ a scanner and/or imager to capture the data encoded in the optical pattern of such machine-readable symbols. Other types of data carriers and associated readers exist, for example magnetic stripes, optical memory tags, and touch memories.

Other types of ADC carriers include RFID tags that may store data in a wirelessly accessible memory, and may include a discrete power source (i.e., an active RFID tag), or may rely on power derived from an interrogation signal (i.e., a passive RFID tag). RFID readers typically emit a radio frequency (RF) interrogation signal that causes the RFID tag to respond with a return RF signal encoding the data stored in the memory.

Identification of an RFID device or tag generally depends on RF energy produced by a reader or interrogator arriving at the RFID tag and returning to the reader. Multiple protocols exist for use with RFID tags. These protocols may specify, among other things, particular frequency ranges, frequency channels, modulation schemes, security schemes, and data formats.

Many ADC systems that use RFID tags employ an RFID reader in communication with one or more host computing systems that act as central depositories to store and/or process and/or share data collected by the RFID reader. In many applications, wireless communications is provided between the RFID reader and the host computing system. Wireless communications allow the RFID reader to be mobile, may lower the cost associated with installation of an ADC system, and permit flexibility in reorganizing a facility, for example a warehouse.

RFID tags typically include a semiconductor device (such as a chip) having the memory, circuitry, and one or more conductive traces that form an antenna. Typically, RFID tags act as transponders, providing information stored in the memory in response to the RF interrogation signal received at the antenna from the reader or other interrogator. Some RFID tags include security measures, such as passwords and/or encryption. Many RFID tags also permit information to be written or stored in the memory via an RF signal.

The read/write range of an RFID tag is often strongly dependent on the type of material composition of the object on which RFID tag is attached. Since an RFID tag is generally an antenna connected to an RFID chip, the performance of the antenna can be severely affected by the presence of metal or other objects in the near-field zone around the antenna. This effect is especially severe for metallic objects, such as for example, airplane parts, metal containers, etc. When a typical passive RFID tag is mounted on such metallic objects, the object(s) will change characteristics of the antenna. These changes can include, for instance, detuning of the resonant frequency of the RFID tag, changing the bandwidth of the RFID tag, lowering the range of the RFID tag, and so forth.

Moreover, various different RFID frequency bands, RFID standards and protocols, RFID applications, etc. are present. For instance, different countries may allocate different frequency bands for RFID use. Existing RFID tags are rather inflexible in that they are manufactured for a specific frequency band, standard/protocol, application etc., and would therefore be incompatible or otherwise inoperative with an RFID reader or other RFID system that is operating based on a different frequency band, standard/protocol, application, etc. Such limitations can limit worldwide use/compatibility of a particular RFID tag designed to operate only at a specific frequency, for example.

### BRIEF SUMMARY

One aspect provides a radio frequency identification (RFID) tag apparatus that includes a flexible antenna inlay structure having a substrate material and an antenna trace affixed to the substrate material. The antenna trace includes a first structure to set a first resonant frequency and a second structure to set a second resonant frequency. An operating frequency band is defined at least in part between the first and second resonant frequencies. The apparatus includes a dielectric having the antenna inlay structure affixed thereto. A metallized label affixed to the dielectric shields the antenna inlay structure from effects of a background object. A protective structure houses and protects the antenna inlay structure, dielectric, and metallized label.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a pictorial diagram showing example RFID tag implementations of an embodiment of an antenna inlay structure.

FIG. 2 is a cross-sectional side view of an embodiment of a rigid metal mount RFID tag having the antenna inlay structure of FIG. 1.

FIG. 3 is a cross-sectional side view showing example dimensions of the embodiment of the rigid metal mount RFID tag of FIG. 2.

FIG. 4 is a cross-sectional side view of an embodiment of a compact rigid metal mount RFID tag having the antenna inlay structure of FIG. 1.

FIG. 5 is a cross-sectional side view showing example dimensions of the embodiment of the compact rigid metal mount RFID tag of FIG. 4.

FIG. 6 is a top view of one embodiment of the antenna inlay structure of FIG. 1.

FIG. 7 is a top view showing example dimensions of one embodiment of the antenna inlay structure of FIG. 1.

FIG. 8 is a top view of another embodiment of the antenna inlay structure of FIG. 1.

FIG. 9 is a top view of yet another embodiment of the antenna inlay structure of FIG. 1.

FIG. 10 is an example plot of range versus frequency corresponding to an embodiment of the rigid metal mount RFID tag of FIGS. 2-3.

FIG. 11 is an example plot of range versus frequency corresponding to an embodiment of the compact rigid metal mount RFID tag of FIGS. 4-5.

FIG. 12 is a cross-sectional side view of another embodiment of an RFID tag having the antenna inlay structure of FIG. 1.

FIG. 13 is a cross-sectional side view of an embodiment of a compact RFID tag having the antenna inlay structure of FIG. 1.

### DETAILED DESCRIPTION

In the following description, numerous specific details are given to provide a thorough understanding of embodiments. One skilled in the relevant art will recognize, however, that the embodiments can be practiced without one or more of the specific details, or with other methods, components, materials, etc. In other instances, well-known structures, materials, or operations associated with RFID tags and RFID readers, computer and/or telecommunications networks, and/or computing systems are not shown or described in detail to avoid obscuring aspects of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Reference throughout this specification and claims to “radio frequency” or RF includes wireless transmission of electromagnetic energy, including, but not limited to, energy with frequencies or wavelengths typically classed as falling in the radio and microwave portions of the electromagnetic spectrum.

The headings provided herein are for convenience only and do not interpret the scope or meaning of the embodiments.

As an overview, an embodiment provides a data carrier, such as an RFID tag, having an antenna printed on a substrate to thereby form an antenna inlay structure. The antenna inlay structure of one embodiment is flexible and can be folded to provide a more compact form factor. The antenna inlay structure of one embodiment can be attached to a dielectric and then placed in a rigid enclosure or coated with a special material to provide a rigid RFID tag (or otherwise covered by a protective structure), such as a metal mount RFID tag that can be affixed to a metallic object or other object.

In one embodiment, a metallic ground plane (such as provided by a metallized label) can be provided inside the rigid enclosure or inside some other protective structure (such as a coating) to serve as electrical shield to minimize the effect of the object on the antenna. The antenna of one embodiment can be provided with several resonant frequencies and is further able to operate according to different frequency bands, standards/protocols, applications, etc. Such embodiments of the RFID tag having the antenna inlay structure thus provides improved and increased capabilities and flexibility as compared to existing RFID tags.

According to various embodiments, the antenna inlay structure, dielectric, and metallized label are either housed in the rigid enclosure or coated with a special vacuum-deposited material (such as Parylene) or other protective structure made from a protective material that covers and protects the antenna inlay structure and/or other internal elements of the RFID tag from chemical exposure, mechanical stress, electrostatic discharge, and so forth.

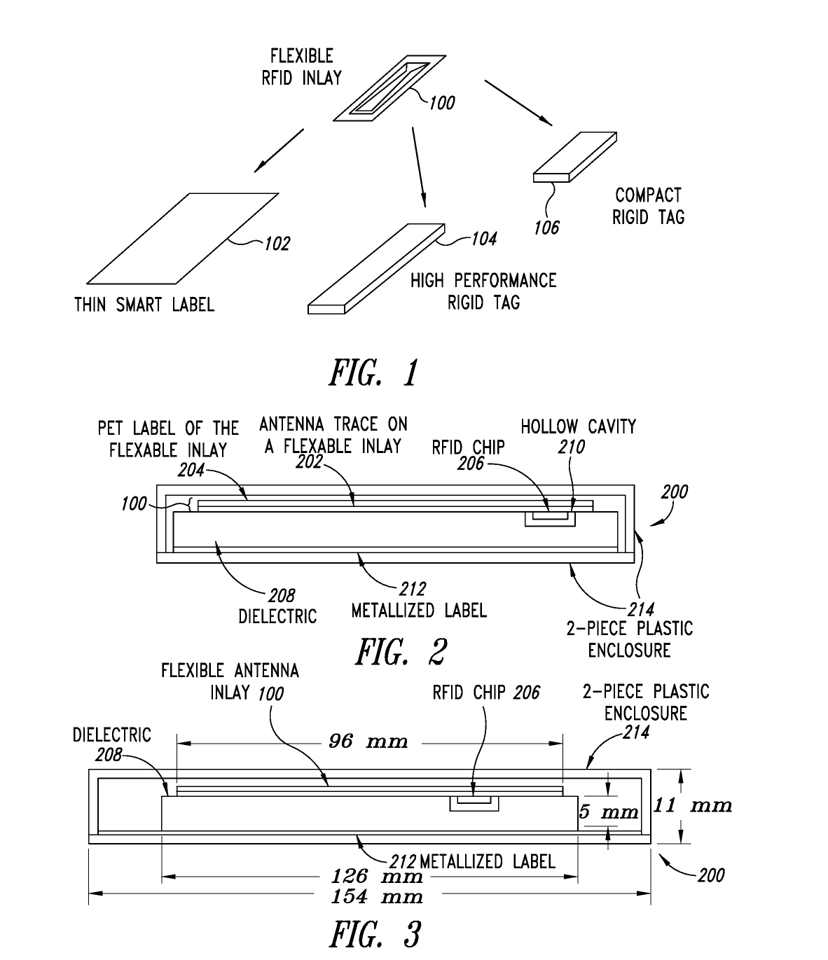

FIG. 1 shows several possible applications of an embodiment of an antenna inlay structure 100. In one embodiment, the antenna inlay structure 100 is flexible and comprises part of an RFID tag. The antenna inlay structure 100 of one embodiment includes the RFID tag's main/primary antenna printed on a substrate (made of plastic or other suitable material). As will be described in further detail below, the antenna inlay structure 100 of one embodiment can be placed on a dielectric material, coupled to an RFID chip, and encapsulated in a housing (such as a plastic enclosure) or otherwise covered with a protective structure (such as a coating of Parylene or other suitable coating material).

In one possible application, the antenna inlay structure 100 may be part of an RFID tag present in a thin “smart label” 102. The relatively thin and flexible characteristics of the antenna inlay structure 100 allows the antenna inlay structure 100 to be used in the smart label 102, without unduly increasing the bulkiness/thickness of the smart label 102 and/or without unduly decreasing the flexibility of the smart label 102. The antenna inlay structure 100 can be coupled to an RFID chip (such as those that will be explained later below), and then appropriately packaged into the smart label 102 using laminates or other suitable material that provides coating, protection, sealant, adhesion, etc. for smart labels.

In another possible application, the antenna inlay structure 100 may be part of a high-performance rigid RFID tag 104. One example of the high-performance rigid RFID tag 104 is a rigid metal mount RFID tag having wide and multiple frequency bands. Embodiments of such a rigid metal mount RFID tag will be described later below.

In another possible application, the antenna inlay structure 100 may be part of a compact rigid RFID tag 106. One example of the compact rigid RFID tag 106 is a compact rigid metal mount RFID tag having a folded antenna inlay structure. Embodiments of such a compact rigid metal mount RFID tag will also be described later below.

FIG. 2 is a cross-sectional side view of one embodiment of a rigid metal mount RFID tag 200 corresponding to the high-performance RFID tag 104 of FIG. 1. An embodiment of the antenna inlay structure 100 of the RFID tag 200 includes an antenna trace 202 printed on or otherwise formed on a substrate material, such as a polyethylene terephthalate (PET) label 204. The substrate material on which the antenna trace 202 is formed can comprise any other type of suitable flexible material, such a plastic or other synthetic material, that may not necessarily have the same material composition and structure as a PET label. For purposes of simplicity of explanation hereinafter, the substrate material of the various embodiments of the antenna inlay structure 100 will be described in the context of a PET label.

The antenna trace 202 of the antenna inlay structure 100 can comprise a conductive ink printed on the PET label 204, wire(s) or other conductive metallic structure formed in or on the PET label 204, or other suitable antenna material (e.g., copper, aluminum, silver, conductive fluid, etc.) that can be placed on and/or embedded in the substrate material. For instance, to form the antenna inlay structure 100, such antenna material can be formed on the surface of the substrate, embedded at least in part in the substrate, “sandwiched” between two substrates, and other configuration(s) including combinations thereof. Further, it is possible in another embodiment wherein multiple substrate layers are provided, with a same and/or different antenna portions being formed in or on the respective substrate layers. The substrate layers and/or antenna portions can further be made of the same material or different materials. For the sake of simplicity of explanation, the antenna inlay structure 100 will be described hereinafter in the context of the antenna trace 202 being formed on (or over) the substrate material, such as the PET label 204.

The antenna trace 202 is electrically coupled to an RFID chip 206. In one embodiment, the RFID chip 206 is a passive RFID chip. In other embodiments, the RFID chip 206 is actively powered by a battery (not shown).

The RFID chip 206 can be compliant with standards/protocols such as ISO 18000-6B or other ISO standard, EPC Global Gen 2, Class 0, Class 1, and so forth. Thus, the RFID tag 200 is compatible and interoperable with RFID readers that support such standards/protocols. The RFID chip 206 has a front end impedance that can be matched with the antenna trace 202, as will be described in further detail below.

The antenna inlay structure 100 of one embodiment is affixed to a dielectric 208, using any suitable affixation technique (e.g., gluing via use of an adhesive), such that the antenna trace 202 is placed against a first surface of the dielectric 208. The dielectric 208 of one embodiment is homogenous and provides a substrate for the antenna inlay structure 100. The dielectric 208 has some flexibility in an embodiment. A person skilled in the art having the benefit of this disclosure will be familiar with the type of materials that can be used for the dielectric 208, such as plastic. To accommodate the RFID chip 206, a hollow cavity 210 can be formed in the first surface of the dielectric 208.

In one embodiment, a metallized label 212 can be affixed to a second surface of the dielectric 208, using any suitable affixation technique (e.g., gluing via use of an adhesive). In the embodiment of FIG. 2, the second surface of the dielectric 208 is depicted as being opposite to the first surface having the antenna inlay structure 100 affixed thereon. However, it is appreciated that in other embodiments, the first and second surfaces of the dielectric 208 need not necessarily have this same spatial relationship.

The metallized label 212 can be made of copper, aluminum, silver ink, or other suitable conductive material. The metallized label 212 forms a ground plane for the antenna trace 202, and serves as an electrical shield for the antenna trace 202 against the effects of the background object (e.g., a metallic object or other object that may be made of wood, plastic, liquid, or other material) on which the RFID tag 200 is attached. Thus, the performance of one embodiment of the RFID tag 200 is insensitive to the electric and/or magnetic properties of the background object. Examples of such objects on which the RFID tag 200 is attachable can include, but not be limited to, tractors and trailers, airplane parts, reusable plastic containers (RPC), metal cages or containers, wood and plastic pallets, unit loading devices, vehicles, personal items (e.g., luggage), appliances, and so on.

In one embodiment, the metallized label 212 has a surface area (or other dimensional characteristic) that exceeds the surface area (or other dimensional characteristic) of the antenna trace 202, thereby further providing adequate shielding/coverage against the background object. Depending on the thickness and/or material composition of the metallized label 212, the metallized label 212 may have some flexibility.

In an embodiment, an enclosure 214 houses the antenna inlay structure 100 and its components, the RFID chip 206, the dielectric 208, and the metallized label 212. The enclosure 214 can be made out of any suitable material that provides some rigidity to these otherwise flexible elements housed therein. An example material for the enclosure 214 is plastic, such as 2-piece plastic enclosure having a base and a cover.

The enclosure 214 further protects the elements housed internally therein against environmental conditions that may otherwise damage such internal elements. For instance in one embodiment, the enclosure 214 is made from impact-resistant plastic that provides rugged protection against extreme temperatures and hazardous exposures that are common in manufacturing and material handling operations. Examples of these temperatures are −40 to +250 degrees Fahrenheit or −40 to +121 degrees Celsius. Examples of the hazardous exposures against which the enclosure 214 is resistant include chemical exposures to machining oil/fluid, gasoline, motor oil, methyl ethyl ketone (MEK), isopropyl alcohol, methyl alcohol, mineral spirits, acetone, kerosene, and others. As will be discussed in further detail below, other embodiments can provide a protective coating, instead of the enclosure 214, to house or otherwise cover and protect the internal components of an RFID tag.

The RFID tag 200 can be attached to an object using screws, rivets, double-sided adhesive strips, hook and loop fastener, or any other suitable attachment method. In one embodiment, for example, the enclosure 214 (or coating) may be provided with mounting holes (not shown) to accommodate screws or rivets.

Moreover, because of the robustness and ruggedness of the RFID tag 200, as provided by the enclosure 214 (or coating) and by the design/configuration of the antenna inlay structure 202 and other internal elements, the RFID tag 200 of one embodiment is reusable. For instance, the enclosure 214 protects the internal elements to extend their useful life and allow continued use of the RFID tag 200 and also provides mounting holes for repeated attachment/detachment. The RFID chip 206 can be provided with a memory having a sufficient size (such as 2048 bits, 96 bits, etc.) and reliability to permit potentially thousands of rewriting operations. Thus, an embodiment of the reusable RFID tag 200 can provide a significant cost savings per unit.

Example dimensions of the RFID tag 200 (in its encapsulated form that includes the enclosure 214 or coating) are a respective length and width of approximately 6 inches by 1 inch (e.g., approximately 15 cm by 2.5 cm). Example dimensions of some of the other elements of the RFID tag 200 are: antenna trace 202 (1 mil thick, wherein 1 mil= 1/1000 inches or approximately 0.0025 cm); PET label 204 (2 mil thick); and metallized label 212 (1 mil thick). The RFID chip 206 of one embodiment can have dimensions consistent with thin-shrink small outline package (TSSOP) chip packaging.

FIG. 3 illustrates other example dimensions, for instance: antenna inlay structure 100 (96 mm long); enclosure 214 (154 mm long by 11 mm thick); and dielectric 208 (126 mm long by 5 mm thick). It is appreciated that such dimensions shown and/or described are merely illustrative and are not intended to be limiting unless expressly recited in one or more claims. Other embodiments may have different dimensions, depending on factors including, but not limited to, particular application of the RFID tag 200, type of materials used for the elements of the RFID tag 200, desired performance characteristics of the RFID tag 200 (such as range and/or frequency), the environment (e.g., air, water, corrosion, temperature, pressure, etc.) in which the RFID tag 200 will be subject to, and so forth.

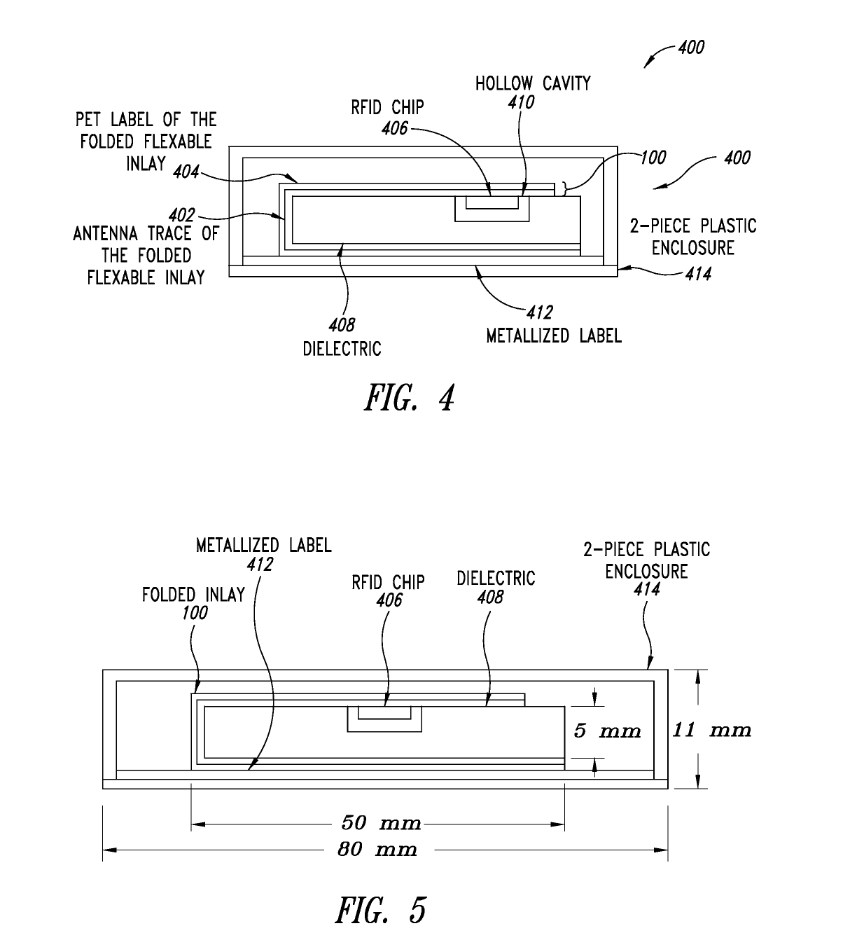

FIG. 4 is a cross-sectional side view of one embodiment of a compact rigid metal mount RFID tag 400 corresponding to the compact rigid RFID tag 106 of FIG. 1. The embodiment of the RFID tag 400 of FIG. 4 includes elements similar to the elements of the embodiment of the RFID tag 200 shown in FIGS. 2-3. In particular, the RFID tag 400 includes an RFID chip 406, a dielectric 408, a hollow cavity 410, a metallized label 412, and an enclosure 414 (or coating), all of which respectively correspond to the RFID chip 206, dielectric 208, hollow cavity 210, metallized label 212, and enclosure 214 (or coating) of the RFID tag 200 of FIGS. 2-3. Such elements of the RFID tag 400 may have similar composition, configuration, use, or other feature or capability as the elements of the RFID tag 200 described above, and therefore, details of such composition, configuration, use, or other feature or capability will not be repeated herein for the sake of brevity.

The RFID tag 400 differs from the RFID tag 200 in that the RFID tag 400 has a more compact form factor relative to the RFID tag 200. In particular, the antenna inlay structure 100 of the RFID tag 400 has been folded over the dielectric 408 to thereby reduce the overall size of the RFID tag 400 without changing the inlay design itself.

In the specific embodiment shown in FIG. 4, the antenna inlay structure 100 includes a PET label 404 (or other suitable substrate material) on which an antenna trace 402 is formed, both of which respectively correspond to the PET label 204 and antenna trace 202 of the RFID tag 200 of FIGS. 2-3. Again for the sake of brevity, the description of the specific composition of the antenna trace 402 and the PET label 404 will not be repeated herein, since such details were previously provided above with respect to the antenna trace 202 and the PET label 204.

It is noted that instead of being entirely affixed to the first surface (e.g., the top surface) of the dielectric 408 as with the embodiment of FIGS. 2-3, the embodiment of the antenna inlay structure 100 of FIG. 4 has a first region affixed to the first surface of the dielectric 408, a second region (contiguous to the first region) folded over and affixed to a side surface of the dielectric 408, and a third region (contiguous to the second region) folded over and affixed to a second surface (e.g., the bottom surface) of the dielectric 408, such that the third region of the antenna inlay structure 100 is “sandwiched” between the bottom surface of the dielectric 408 and the metallized label 412.

In one embodiment, the antenna inlay structure 100 is folded such that the antenna trace 402 is affixed proximate to the dielectric 408 and the PET label 404 is distal to the dielectric 408. Moreover, while FIG. 4 shows an embodiment where the antenna inlay structure 100 is folded contiguously only over three surfaces of the dielectric 408, it is possible to provide other embodiments where the antenna inlay structure 100 is folded over additional surfaces of the dielectric 408.

The folding of the antenna inlay structure 100 reduces the “footprint” of the antenna inlay structure 100, thereby allowing a decrease in the size of the dielectric 408, the metallized label 412, and the enclosure 414. This collective reduction in size of these internal elements contributes to an overall reduction in size of the RFID tag 400.

For instance, example dimensions of the RFID tag 400 (in its encapsulated form that includes the enclosure 414 or coating) are a respective length and width of approximately 3 inches by 1 inch (e.g., approximately 7.5 cm by 2.5 cm)—thus, the overall length of the RFID tag 400 can be reduced by half, for example, as compared to the length of the RFID tag 200 of FIGS. 2-3. Example dimensions of some of the other elements of the RFID tag 400 are: antenna trace 202 (1 mil thick); PET label 204 (2 mil thick); and metallized label 212 (1 mil thick)—such thicknesses can be consistent with or otherwise similar to the thicknesses of the RFID tag 200 of FIGS. 2-3. The RFID chip 406 of one embodiment can have dimensions consistent with TSSOP chip packaging.

FIG. 5 illustrates other example dimensions of the RFID tag 400, for instance: antenna inlay structure 100 (50 mm long); enclosure 414 (80 mm long by 11 mm thick); and dielectric 208 (80 mm long by 5 mm thick). Thus, there is an overall reduction in length/width as compared to the embodiment(s) of FIGS. 2-3. Again, it is appreciated that such dimensions shown and/or described are merely illustrative and are not intended to be limiting unless expressly recited in one or more claims. Other embodiments may have different dimensions, depending on factors including, but not limited to, particular application of the RFID tag 400, type of materials used for the elements of the RFID tag 400, desired performance characteristics of the RFID tag 400 (such as range and/or frequency), the environment (e.g., air, water, corrosion, temperature, pressure, etc.) in which the RFID tag 400 will be subject to, and so forth.

While embodiments have been described above in which the enclosure 214 (such as in the form of rigid plastic) has been provided to house the internal elements of the RFID tag 200/400, it is appreciated that other embodiments can provide other types of protective structure to cover the internal elements of the RFID tag. For example, one or more other embodiments coat the antenna inlay structure 100, RFID chip, dielectric, and metallized label with a suitable protective material. Such coating protects the RFID tag from chemical exposure, mechanical stress, and electrostatic discharge and eliminates the need for a plastic housing in many RFID tag applications.

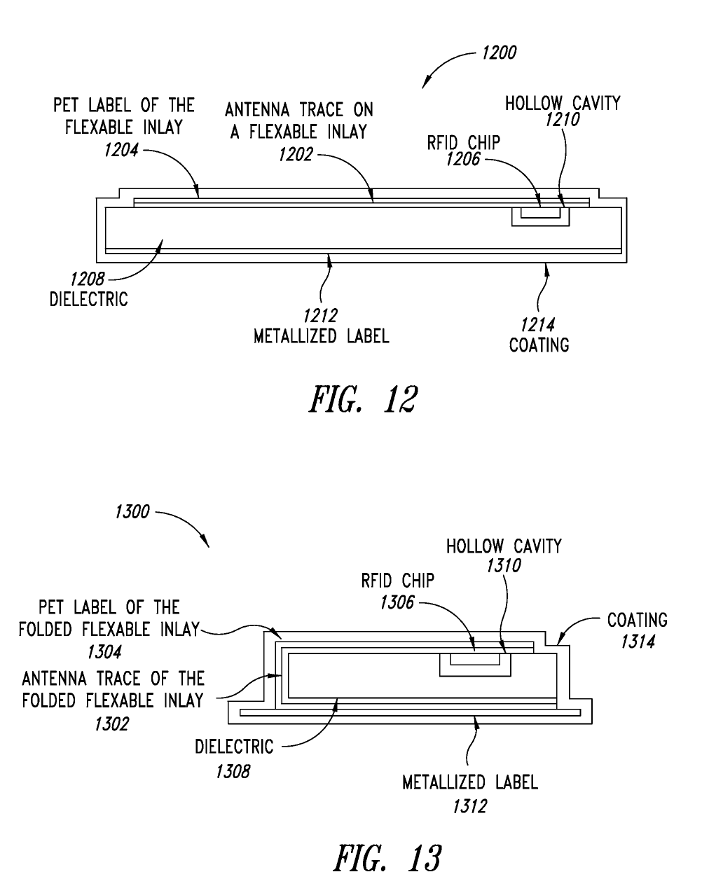

FIGS. 12-13 show examples of such other embodiments that use a protective coating. In FIG. 12, an RFID tag 1200 includes internal elements corresponding to the internal elements previously described above, such as an antenna trace 1202, PET label 1204, RFID chip 1206 present in a hollow cavity 1210 in a dielectric 1208, and a metallized label 1212.

However, instead of using an enclosure (such as the enclosure 214 of FIG. 2), the embodiment of the RFID tag 1200 provides a protective coating 1214 or other suitable protective structure that houses and protects the internal elements of the RFID tag 1200. In an embodiment, the coating 214 is a thin layer of vacuum deposited special material. An example of this protective material is Parylene.

FIG. 13 shows an embodiment of a compact RFID tag 1300 that corresponds to the compact RFID tag 400 of FIG. 4. The RFID tag 1300 also includes internal elements corresponding to the internal elements previously described above, such as an antenna trace 1302, PET label 1304, RFID chip 1306 present in a hollow cavity 1310 in a dielectric 1308, and a metallized label 1312. As with the embodiment of FIG. 12, the embodiment of the RFID tag 1300 of FIG. 13 includes a protective coating 1314, such as a Parylene coating.

Parylene is produced by vapor-phase deposition and polymerization of para-xylylene (or its substituted derivatives). Parylene as a vacuum deposited plastic has the quality of coating in a uniform manner. Parylene further has the qualities of resistance to chemical attacks, superior dielectric strength, a very low dissipation factor, excellent mechanical strength, very high surface and volume resistivities, and other superior electrical properties that exhibit low sensitivity to changes in temperature.

To apply parylene, a vacuum application process may be used, in which a dimer is placed in a vacuum system and converted to a reactive vapor of the monomer. When passed over room temperature objects, this vapor will rapidly coat the objects with a polymer. The result is a substantially impervious uniform finish/coating.

In some embodiments, the protective coating 1214/1314 provides rigidity to the RFID tag 1200/1300. In other embodiments, the protective coating 1214/1314 is made of a material that has some flexibility, thereby providing the RFID tag 1200/1300 with some flexibility as well. Various embodiments of the RFID tags 1200/1400 that use a protective coating can have dimensions similar to those previously described above for the RFID tags 200/400.

FIG. 6 shows one example embodiment of the antenna trace 202/402 of the antenna inlay structure 100. The illustrated embodiment of the antenna trace 202/402 includes a first (outer ring) structure 600 and a second (stub) structure 602 coupled and combined together. The outer ring structure 600 can have a rectangular (as shown), circular, or other shape, and operates as a magnetic-type loop-like radiating structure over a ground plane in one embodiment. The stub structure 602 can have a wavelength of one-quarter or longer wavelength, and operates as an electric-type radiating structure in one embodiment. The antenna inlay structure 100 of FIG. 6 can be viewed in some embodiments as a patch-type antenna structure having an offset center feed (from the RFID chip 206/406) and a virtual ground short (provided by the metallized label 212/412).

An impedance matching element (symbolically depicted by the broken lines 604) couples the stub structure 602 to the RFID chip 206/406 and to the ring structure 600. The impedance matching element 604 of one embodiment can comprise a trace having a tapered, meandered, rectangular, or other suitable shape. The impedance matching element 604 operates to match the front end input impedance of the RFID chip 206/406 to the antenna inlay structure 100. Thus, given that various RFID chips 206/406 may have different front end input impedances depending on various design parameters of the RFID chips 206/406, a different impedance matching element 604 may be present from one RFID tag to another, so as to optimally match the front end input impedance of the RFID chip to the antenna inlay structure 100.

In an embodiment, the antenna inlay structure 100 of one embodiment has at least two resonant frequencies. In general, the stub structure 602 sets an upper resonant frequency, while the ring structure 600 sets a lower resonant frequency. Since the stub structure 602 and the ring structure 600 are coupled together, the frequency separation between the upper and lower resonant frequencies is related to an overall length/width of the ring structure 600 and to the length of the stub structure 602 with the impedance matching element 606. This frequency separation between the upper and lower resonant frequencies define at least a portion of the operating frequency band(s) (e.g., the read frequencies or read range bandwidth) of the RFID tag 200/400.

Accordingly, by manipulating such dimensional characteristics of the ring structure 600 and the stub structure 602, a desired read range bandwidth of the RFID tag 200/400 can be achieved by matching the upper and lower resonant frequencies for a particular impedance of the RFID chip 206/406.

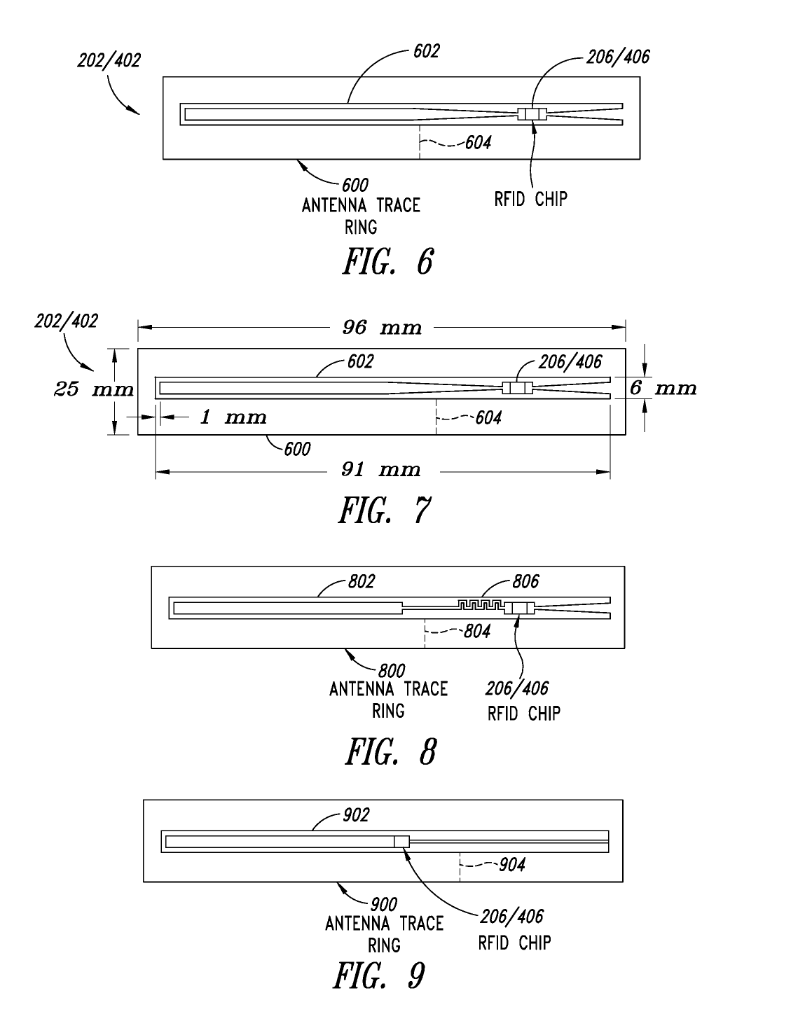

Example dimensions of the antenna trace 202/402 of FIG. 6 are shown in FIG. 7. These example dimensions include: a length of 96 mm and width of 25 mm (for the ring structure 600); and a length of 91 mm, and a width of 6 mm. Again, it is appreciated that such dimensions shown and/or described are merely illustrative and are not intended to be limiting unless expressly recited in one or more claims. Other embodiments may have different dimensions, depending on factors including, but not limited to, particular application, type of materials used, desired performance characteristics, environmental conditions, and so forth.

FIGS. 8 and 9 show other possible embodiments of the antenna trace 202/402 of the antenna inlay structure 100. Such embodiments include, in a manner similar to the embodiment of FIGS. 6-7, a ring structure 800/900, a stub structure 802/902, and an impedance matching element 804/904. Some of the notable differences from the embodiment of FIGS. 6-7 are the shapes of the stub structures 802/902.

For instance, the embodiment of the stub structure 802 of FIG. 8 includes a region 806 where portions of the stub structure 802 interleave with one another. The embodiment of the stub structure 902 of FIG. 9 is generally shaped such that the RFID chip 206/406 is located centrally within the stub structure 902 to provide a substantially central feed, whereas the RFID chip 206/406 is located offset from the center of the stub structures 602 and 802 of FIGS. 6 and 8, respectively.

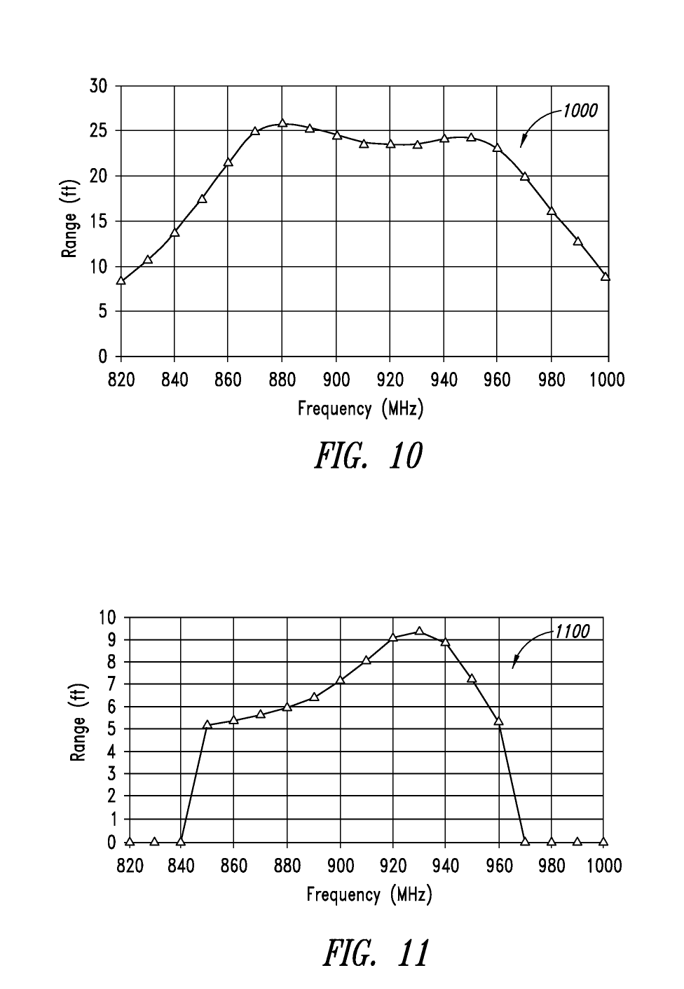

To provide a comparison of range or bandwidth between the embodiments of the RFID tags 200 and 400 of FIGS. 2 and 4, respectively, example plots of range versus frequency are shown in FIGS. 10-11. It is appreciated that the values of range (in feet) and frequency (in megahertz) in FIGS. 10-11 are being provided only for the purpose of illustration, and that other embodiments of the RFID tags 200 and 400 (as well as the other RFID tags shown in FIG. 1) may have different values for range and frequency than those shown in FIGS. 10-11. Values for the range may vary from one RFID tag to another depending on factors such as RFID reader power output, temperature or other environmental factors, specific application of the RFID tag, configuration of the antenna inlay structure of the RFID tag, and so forth.

The various antenna trace designs shown and described above can be adapted for use in the RFID tags 1200 and 1300 of FIGS. 12 and 13, respectively, that use an outer protective coating. For the sake of brevity, the manner in which such antenna trace designs can be coupled within and used in the RFID tags 1200 and 1300 will not be repeated herein.

FIG. 10 is an example plot 1000 of range versus frequency corresponding to an embodiment of the rigid metal mount RFID tag 200 of FIGS. 2-3. It is assumed for purposes of illustration that the plot 1000 corresponds to a situation where the RFID tag 200 is mounted to a metal object (e.g., a flat metal plate) and that the values of range/frequency are measured for an effective isotropic radiated power (EIRP)=4W in free space. As shown in the plot 1000, the RFID tag 200 has two resonant frequencies and provides at least 23 feet of read range over the frequency band of 860 MHz to 960 MHz.

Thus, one embodiment of the RFID tag 200 is able to operate in various countries around the world that designate different ultrahigh frequency (UHF) bands for RFID use. Examples of such UHF RFID frequencies include, but are not limited to, 869 MHz, 915 MHz, and 955 MHz. Accordingly, one embodiment of the RFID tag 200 having such multiple-band capability can be used for global operations, thereby allowing an enterprise (e.g., a company) to use a single RFID tag 200 for its products worldwide, in which such RFID tag 200 might travel across different countries that use different frequency bands for reading RFID tags. Such an enterprise can therefore eliminate the expensive and inefficient need to create/design customized RFID tags for each individual country, where such RFID tags might have limited operability outside of their country-of-design.

FIG. 11 is an example plot 1100 of range versus frequency corresponding to an embodiment of the compact rigid metal mount RFID tag 400 of FIGS. 4-5. Again, it is assumed for purposes of illustration that the plot 1100 corresponds to a situation where the RFID tag 400 is mounted to a metal object (e.g., a flat metal plate) and that the values of range/frequency are measured for EIRP=4W in free space. As shown in the plot 1100, the RFID tag 400 has two resonant frequencies and provides between 5 and 9 feet of read range over the frequency band of 860 MHz to 960 MHz in one embodiment.

As with the RFID tag 200 described with reference to FIG. 10, one embodiment of the RFID 400 corresponding to FIG. 11 also can be used for worldwide applications where different RFID frequencies may be present from one country to another. It is noted that while the reduction in size of the RFID tag 400 (relative to the size of the RFID tag 200) has resulted in a tradeoff (e.g., a reduction in read range), optimizing the design parameters of the antenna trace 402 (as explained above) for the folded configuration can still achieve a reasonable performance over the entire 860 MHz to 960 MHz frequency band, as shown in FIG. 11.

Embodiments of the RFID tags 1200 and 1300 that use the outer protective coating (instead of the enclosures 214 and 414) exhibit performance characteristics similar to those shown and described above. Thus in some embodiments, using the protective coating (such as a coating made from Parylene) does not significantly affect the read range performance in comparison to using the enclosures 214 and 414.

With the ruggedness, reusability, and worldwide compatibility of embodiments of the various RFID tags described above, an enterprise (or other party) can use a single RFID tag to identify and track objects (such as subassemblies, work-in-process components, finished goods, material handing equipment, logistics containers, etc.) through production, supply chains, and asset/inventory management operations that may span different countries or other geographic regions having different environments and requirements. The reusability of embodiments of such RFID tags further reduces the total cost of ownership.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, embodiments have been described above for the antenna inlay structure 100 corresponding to the rigid metal mount RFID tags 200 and 400 (as well as the RFID tags 1200 and 1300). It is appreciated that such embodiments of the antenna inlay structure 100 (e.g., the material composition, antenna trace and substrate configuration, etc. of the antenna inlay structure) can be adapted or otherwise used for the smart label 102 of FIG. 1 or for other RFID tag implementations.

Further, specific embodiments have been described above in the context of the protective structure of the RFID tags being the enclosure 214 or 414. Such description can be applied to embodiments wherein the protective structure is made from a protective coating, such as Parylene or other suitable material.

These and other modifications can be made to the embodiments in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A radio frequency identification (RFID) tag apparatus, comprising:
a flexible antenna inlay structure having a substrate material and an antenna trace affixed to the substrate material, the antenna trace including a first structure to set a first resonant frequency and a second structure to set a second resonant frequency, an operating frequency band being defined at least in part between the first and second resonant frequencies;
a dielectric having the antenna inlay structure affixed thereto;
a metallized label affixed to the dielectric to shield the antenna inlay structure from effects of a background object; and
a protective structure to house and protect the antenna inlay structure, dielectric, and metallized label.

2. The apparatus of claim 1 wherein the first structure includes a ring structure and wherein the first resonant frequency set by the first structure is a lower resonant frequency, and wherein the second structure includes a stub structure and wherein the second resonant frequency set by the second structure is an upper resonant frequency.

3. The apparatus of claim 1 wherein the operating frequency band ranges between approximately 860 MHz and 960 MHz.

4. The apparatus of claim 1, further comprising:
an RFID chip having a front end input impedance; and
an impedance matching element coupled to the RFID chip and the antenna trace to match the front end input impedance of the RFID chip to an impedance of the antenna inlay structure.

5. The apparatus of claim 1 wherein the substrate material of the antenna inlay structure is part of a polyethylene terephthalate (PET) label.

6. The apparatus of claim 1 wherein the antenna inlay structure is contiguously folded over the dielectric to provide a compact form factor.

7. The apparatus of claim 6 wherein the antenna inlay structure includes:
a first region affixed to the first surface of the dielectric;
a second region, contiguous to the first region, folded over and affixed to a side surface of the dielectric; and
a third region, contiguous to the second region, folded over and affixed to a second surface of the dielectric.

8. The apparatus of claim 1 wherein the antenna trace is proximate to the dielectric and wherein the substrate material is distal relative to the dielectric.

9. The apparatus of claim 1 wherein the protective structure includes a rigid enclosure made from an impact-resistant plastic that is adapted to provide protection against chemical exposure and mechanical stress, or includes a protective coating that is adapted to provide protection against chemical exposure, mechanical stress, and electrostatic discharge.

10. The apparatus of claim 1 wherein the first structure of the antenna trace is a magnetic-type loop-like radiating structure, and wherein the second structure of the antenna trace is an electric-type radiating structure.

11. The apparatus of claim 1, further comprising an RFID chip coupled to the second structure of the antenna trace to provide an offset center feed to the antenna trace.

12. The apparatus of claim 1, further comprising an RFID chip coupled to the second structure of the antenna trace to provide a substantially central feed to the antenna trace.

13. A radio frequency identification (RFID) tag apparatus, comprising:
a dielectric;
a flexible antenna inlay structure affixed to the dielectric, the antenna inlay structure being contiguously folded over surfaces of the dielectric to reduce a footprint of the antenna inlay structure;
a metallized label affixed to the antenna inlay structure to shield the antenna inlay structure from electromagnetic effects of a background object; and
a protective structure to cover the antenna inlay structure, dielectric, and metallized label.

14. The apparatus of claim 13 wherein the antenna inlay structure includes a substrate material and an antenna trace affixed to the substrate material, the antenna trace being proximate to the dielectric and the substrate material being distal to the dielectric.

15. The apparatus of claim 14 wherein the antenna trace includes a first structure to set a first resonant frequency and a second structure to set a second resonant frequency, an operating frequency band being defined at least in part between the first and second resonant frequencies.

16. The apparatus of claim 15 wherein the first structure of the antenna trace is a magnetic-type loop-like radiating structure, and wherein the second structure of the antenna trace is an electric-type radiating structure.

17. The apparatus of claim 13, further comprising:
an RFID chip having a front end input impedance; and
an impedance matching element coupled to the RFID chip and the antenna inlay structure to match the front end input impedance of the RFID chip to an impedance of the antenna inlay structure.

18. A radio frequency identification (RFID) tag apparatus, comprising:
an RFID chip having an impedance;
a flexible antenna inlay structure having a substrate material and an antenna trace affixed to the substrate material, the antenna trace including a first structure to set a first resonant frequency and a second structure to set a second resonant frequency, an operating frequency band being defined at least in part between the first and second resonant frequencies; and
an impedance matching element to couple the RFID chip to antenna inlay structure, the impedance matching element being adapted to match the impedance of the RFID chip with an impedance associated with the antenna inlay structure.

19. The apparatus of claim 18 wherein the impedance of the RFID chip is a front end input impedance, and wherein the impedance associated with the antenna inlay structure is an impedance of the antenna trace.

20. The apparatus of claim 18 wherein the RFID chip, antenna inlay structure, and impedance matching element form part of a smart label.

21. The apparatus of claim 18 wherein the RFID chip, antenna inlay structure, and impedance matching element form part of a rigid metal mount RFID tag that includes:
a dielectric affixed to the antenna inlay structure, the dielectric having first and second surfaces, the antenna inlay structure being positioned proximate to the first surface of the dielectric;
a metallized label to shield the antenna inlay structure against electromagnetic effects associated with a background object, the metallized label being positioned proximate to the second surface of the dielectric; and
a protective structure to cover the RFID chip, antenna inlay structure, impedance matching element, dielectric, and metallized label, the protective structure including a rigid enclosure or a protective coating.

22. The apparatus of claim 21 wherein the rigid metal mount RFID tag has a compact form factor that is provided based on a contiguous folding of the antenna inlay structure, the antenna inlay structure including:
a first region affixed to the first surface of the dielectric;
a second region, contiguous to the first region, folded over and affixed to a side surface of the dielectric; and
a third region, contiguous to the second region, folded over and affixed to the second surface of the dielectric, the third region being located between the second surface of the dielectric and the metallized label.

23. The apparatus of claim 18 wherein the first resonant frequency is a lower resonant frequency and wherein the first structure of the antenna trace is a magnetic-type loop-like radiating structure that sets the lower resonant frequency, and wherein the second resonant frequency is an upper resonant frequency and wherein the second structure of the antenna trace is an electric-type radiating structure.

24. A method, comprising:
setting a first structure of an antenna trace to a first resonant frequency;
setting a second structure of the antenna trace to a second resonant frequency, a frequency separation between first and second resonant frequencies defining at least a portion of an operating frequency band;
affixing the antenna trace to a flexible substrate to form a flexible antenna inlay structure; and
coupling a radio frequency identifier (RFID) chip to the antenna trace.

25. The method of claim 24 wherein setting the first and second structure to the first and second resonant frequencies, respectively, includes defining said at least the portion of the operating frequency band by:
manipulating dimensional characteristics associated with the first and second structures; and
matching an impedance associated with the RFID chip to an impedance associated with the antenna inlay structure.

26. The method of claim 24, further comprising:
affixing the antenna inlay structure to a dielectric;
affixing a metallized label proximate to the dielectric, the metallized label being adapted to provide the antenna inlay structure with insensitivity to background electromagnetic effects; and
enclosing the antenna inlay structure, RFID chip, dielectric, and metallized label in a rigid enclosure.

27. The method of claim 24, further comprising:
affixing the antenna inlay structure to a dielectric;
affixing a metallized label proximate to the dielectric, the metallized label being adapted to provide the antenna inlay structure with insensitivity to background electromagnetic effects; and
coating the antenna inlay structure, RFID chip, dielectric, and metallized label with a protective material that protects against chemical exposure, mechanical stress, and electrostatic discharge.

28. The method of claim 27 wherein coating with the protective material includes coating with a thin layer of vacuum deposited material.

29. The method of claim 28 wherein coating with the thin layer of vacuum deposited material includes coating with Parylene.

30. The method of claim 27 wherein affixing the antenna inlay structure to the dielectric includes contiguously folding the antenna inlay structure over surfaces of the dielectric to reduce a footprint of the antenna inlay structure.

31. The method of claim 26 wherein affixing the antenna inlay structure to the dielectric includes contiguously folding the antenna inlay structure over surfaces of the dielectric to reduce a footprint of the antenna inlay structure

32. The method of claim 24, further comprising packaging the antenna inlay structure and the RFID chip as a smart label.
